(19) United States
(12) Patent Application Publication
(10) Pub. No.: US 2017/0374046 A1
(43) Pub. Date: Dec. 28, 2017

(54) SHORT RANGE SECURE DATA COMMUNICATION

(71) Applicant: PAYPAL, INC., San Jose, CA (US)

(72) Inventors: Srivathsan Narasimhan, San Jose, CA (US); Michael Charles Todasco, San Jose, CA (US); Hayden Padgett, San Jose, CA (US)

(21) Appl. No.: 15/261,479

(22) Filed: Sep. 9, 2016

Related U.S. Application Data
(63) Continuation-in-part of application No. 15/193,487, filed on Jun. 27, 2016.

(51) Int. Cl. H04L 29/06; G06Q 20/38; G06Q 20/32; H04W 12/06; H04W 12/04

(52) U.S. Cl. CPC H04L 63/06; H04W 12/06; H04W 12/04; G06Q 20/3278; H04L 63/083; G06Q 20/3829; G06Q 2220/00

(57) ABSTRACT

Systems and methods for transmitting user data among user devices u are disclosed. An example method includes: wirelessly detecting, using a trusted user device, presence of one or more user devices within a predefined proximity to the trusted user device. The trusted device stores a user credential associated with an application installed on the trusted user device. The method further includes: determining that the application is installed on a first user device in the one or more user devices; identifying a user indication to enable the user credential on the first user device; responsive to identifying the user indication, wirelessly transmitting the user credential from the trusted user device to the first user device; and enabling the user credential in the application installed on the first user device.

### RELATED APPLICATIONS

The application is a continuation-in-part of U.S. patent application Ser. No. 15/193,487, filed Jun. 27, 2016, entitled “Secure Key Based Trust Chain Among User Devices,” which is hereby incorporated by reference in its entirety.

### BACKGROUND

The present application relates to secure data communication between devices and more particularly to securely communicating user credentials between devices using short range communications.

Requiring a user to replicate data from one device to another device can be time-consuming and hence frustrating. For example, when operating software applications (or apps) on a different user's smartphone, a user may be required to provide her login credentials as well as other application data, e.g., user preferences. The problem exacerbates when a user uses a large number of apps or operates multiple devices.

There is therefore a need for a device, system, and method, which reduces the amount of user effort required for transmitting user data (e.g., user credentials) from one device to another device.

### BRIEF DESCRIPTION OF THE FIGURES

FIG. 1 is a schematic view illustrating an embodiment of a system for providing a secure key based trust chain among several user devices.

FIG. 2 is a schematic view illustrating an embodiment of a system for providing a secure key based trust chain among several user devices.

FIG. 3 is a flow chart illustrating an embodiment of a method for providing a secure key based trust chain among several user devices.

FIG. 4 is a sequence diagram illustrating an embodiment of a method for providing a secure key based trust chain among several user devices.

FIG. 5 is a schematic view illustrating an embodiment of a method for authorizing, though a trusted device, a transaction being conducted on an untrusted device.

FIG. 6 is a flow chart illustrating an embodiment of a method for providing a secure key based trust chain among several user devices.

FIG. 7 is a schematic view illustrating an embodiment of a computing system.

FIG. 8 is a schematic view illustrating an embodiment of a user device.

FIG. 9 is a schematic view illustrating an embodiment of a hardware architecture of a trust zone.

FIG. 10 is a schematic view illustrating an embodiment ofa software architecture of a trust zone.

FIG. 11 is a schematic view illustrating various models for a trust chain.

FIG. 12A is a schematic view illustrating an embodiment of a system for transmitting user data among user devices.

FIG. 12B is a schematic view illustrating an embodiment of a system for transmitting user data among user devices.

FIG. 13 is a schematic view illustrating an embodiment of a system for transmitting user data among user devices.

FIG. 14 is a flow chart illustrating an embodiment of a method for transmitting user data among user devices.

FIG. 15 is a flow chart illustrating an embodiment of a method for transmitting user data among user devices.

FIG. 16 is a schematic view illustrating an embodiment of a user device.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

The present disclosure provides systems and methods for creating and maintaining a secure key based trust chain among several (e.g., two or more) user devices. In one embodiment, after receiving, from a tablet computer, a user request to log into an application, e.g., a payment application that requires either (1) a user name and a corresponding password or (2) a fingerprint-based user authentication, a server system identifies a trusted device of the user, e.g., the user's smartphone, and transmits to the smartphone, a verification request to approve or deny the request to login on another user device, e.g., the user's tablet computer. If the user approves the request on the smartphone, then the tablet computer can be deemed another trusted device of the user. A secure key (also referred to as a key in the present disclosure) can be transmitted to and stored in a secure hardware component of the tablet computer—which converts the tablet computer into a trusted device of the user—so that future logins using the same user name into the payment application on the tablet computer do not require the user to provide a password.

As such, a user can create and maintain a chain of trusted devices, each of which maintains a same or different secure key associated with a user name. As such, future logins and transactions under the user name (through the payment application or any other applications) on the trusted devices within the chain would not require the user to manually provide passwords, while maintaining security of transactions performed through the different user devices.

The systems and methods described in the present disclosure can provide a variety of technical advantages. First, password input can be reduced or eliminated, because a user can be authenticated through a secure key stored on a trusted device, without the user having to provide a password for login purposes.

Second, session- or cookie-based communications, which are more susceptible to unauthorized access (e.g., a session-id hijack), can therefore be replaced with the secure key-based communications. Here, a secure key can serve as not only a user device side login password, but also a user device identifier when communicating with a server.

Third, fraudulent transactions can be detected. For example, if two trusted devices of a user are transacting from different locations (e.g., New York City in the State of New York and San Francisco in the State of California, which are approximately 3,000 miles from each other) at the same time, the system may consider one of these two transactions as not belonging to the user and, as a result, deny the transaction.

Fourth, user progress data (also referred to as context data or save and resume data in the present disclosure) that describe a user's work process on one application or device can be shared with other applications or other trusted devices of the user's, enabling the user to resume work on a different application or a different trusted device. User preference data can be similarly replicated from one trusted device to another. Technologies related to managing user data across multiple devices are described in U.S. patent application Ser. No. 15/198,807, filed on Jun. 30, 2016, entitled “systems and methods for user data management across multiple devices,” with Srivathsan Narasimhan, Srinivasan Rangaraj, and Aravindan Ranganathan, as inventors.

Additional details of implementations are now described in relation to the Figures.

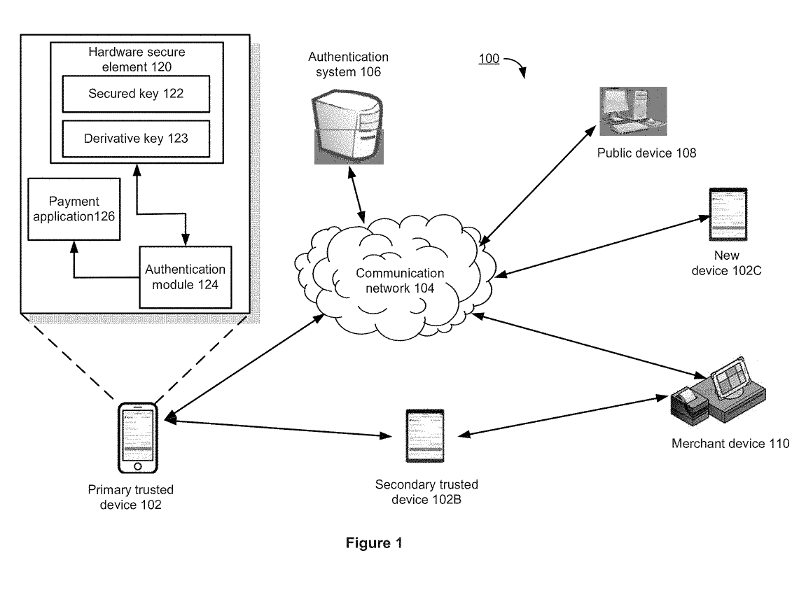

FIG. 1 is a schematic view illustrating an embodiment of a system 100 for providing a secure key based trust chain among several user devices. The system 100 may comprise or implement a plurality of servers and/or software components that operate to perform various technologies provided in the present disclosure.

As illustrated in FIG. 1, the system 100 may include a plurality of devices (e.g., 102, 102B, and 102C), an authentication system 106, a public device 108, and a merchant device (e.g., a POS device) 110 in communication over a communication network 104.

In one embodiment, the device 102 (also referred to as a user device in the present disclosure) may enable a user to authenticate herself on the device and to, after a successful authentication, conduct a transaction e.g., with a merchant device, via the communication network 104.

In some embodiments, the device 102 may include a secure element 120, an authentication module 124, and a payment application 126. The user device 102 may be implemented as a smart phone, a tablet computer, a laptop computer, a personal computer, or other computing devices.

The secure element 120 includes a hardware storage area for storing private data—such as a digital identification (ID) or a password of a user—in such a way that it is difficult to compromise (e.g., with multiple levels of encryptions or access restrictions). For example, a secure element of a device may be located in a Universal Integrated Circuit Card (UICC), a Subscriber Identity Module (SIM) card, Secure Data (SD) card or embedded Secure Element (eSE), any of which may be plugged into or otherwise connected with a user device.

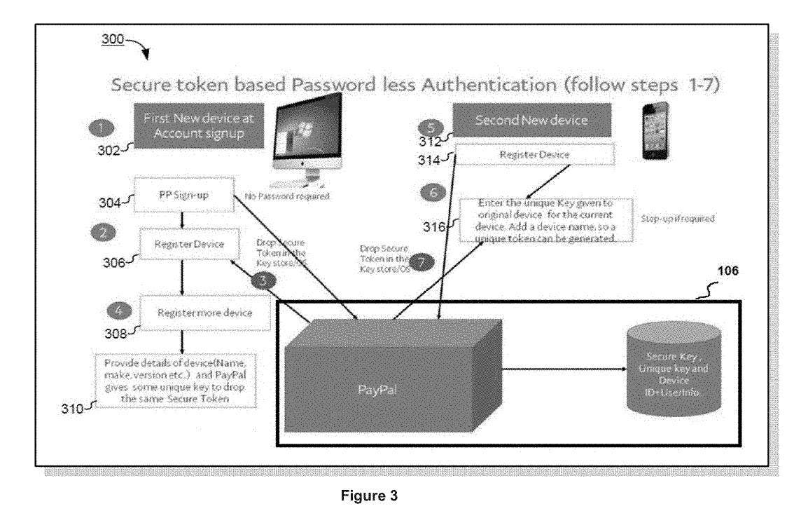

In some embodiments, the secure element 120 stores one or more keys identifying a user or her login identifier. The one or more keys may include a primary key 122 and optionally a derivative key 123. Technologies relating to key generation, storage and verification are explained in greater detail with reference to FIGS. 3-5.

In some embodiments, the user device 102 includes an authentication module 124 which may be used to authenticate a user on the user device 102. In some embodiments, the authentication application 124 may determine whether to authenticate a user on the user device based on a key stored in the secure element 102, without asking a user to provide a password. For example, after receiving a user's login identifier for the payment application 126, the authentication module 124 may search for a corresponding key in the secure element 120. If the authentication module 124 finds the corresponding key in the secure element 120, the authentication module 124 may determine the user authenticated on the device 102, e.g., for the purpose of accessing the payment application 126.

In one alternative embodiment, the authentication module 124 may collect credentials from a user and compare the collected credentials with previously accepted credentials to decide whether to authenticate a user. For example, the authentication module 154 may (1) collect, from a user, a user or device identifier such as an email address, device ID, user name, a password or PIN, an audio/video fingerprint, biometric data (e.g., voice, fingerprint, gesture), or other credential information, (2) match credential information to previously accepted or stored credential information, and (3) authenticate the user when a match occurs.

In one other alternative embodiment, the authentication module 124 may authentication a user using FIDO technologies. The password-less FIDO technology is supported by the Universal Authentication Framework (UAF) protocol. In some embodiments, a user registers her device to the online service by selecting a local authentication mechanism such as swiping a finger, looking at the camera, speaking into the mic, entering a PIN, etc. The UAF protocol allows the service to select which mechanisms are presented to the user.

The second factor FIDO technology is supported by the Universal Second Factor (U2F) protocol. This technology allows online services to augment the security of their existing password infrastructure by adding a strong second factor to user login. The user logs in with a usemame and password as before. The service can also prompt the user to present a second factor device at any time it chooses. The strong second factor allows the service to simplify its passwords (e.g. 4-digit PIN) without compromising security.

In some embodiments, a device 102 uses another element that is as secure as the secure element, when the secure element is not available, e.g., not feasible to install a secure element on the device. The other element may be a software package that encrypts user credentials.

The payment application 152 may be used, for example, to initiate a payment from a user account (e.g., maintained by a payment service system) to a payee (e.g., a merchant device or another user device) over the communication network 104. The payment application 152 may be implemented as a smartphone app or a web browser.

In some embodiments, a user device 102 is considered a trusted device after a user registers the user device 102 with a service provider (also referred to as a device on-boarding process in the present disclosure). For example, after meeting a predefined number of authentication criteria, a user can register, with the service provider, a corresponding device identifier (e.g., a phone number or an IMEI number) that identifies the user device 102. After a successful on-boarding process, the service provider may generate a key based on the device identifier, a user identifier, or both, and store the key in a secure element of the user device 102. In some embodiments, a user may have two or more trusted devices, e.g., the primary trusted device 102 and the secondary trusted device 102B.

In some implementations, the communication network 104 communicatively interconnects one or more of the user devices 102 with each other, with the authentication system 106, and/or with a public device 108. In some implementations, the communication network 104 optionally includes the Internet, one or more local area networks (LANs), one or more wide area networks (WANs), other types of networks, or a combination of such networks.

In an embodiment, the authentication system 106 authenticates a user on one or more user devices by (1) forwarding an authentication request on a new user device (which is also referred to as an untrusted device) to a trusted device for user approval (or denial), and (2) when the request is approved, authenticating the user on the new user device. The authentication system 106 may additionally generate and store a secure key on the new user device, after which the new user device can become a trusted device.

In an embodiment, the public device 108 includes a device that is accessible to the general public or to more than a predefined number of users who are not related to each other within a predefined number of connections, e.g., strangers rather than family members. For example, the public device 108 may be a computer in a public library or a school computer lab. In an embodiment, upon determining that a device includes a public device, the authentication system 106 refrains from storing a key on the device, because storing the key on a public device, even in an encrypted form, may increase of the risk of jeopardizing private user information. In some embodiments, therefore, a public device is not deemed a trusted device by the authentication system 106, regardless the frequency of user logins from the public device. In another embodiment, whether a device is public may be defined by the user and/or the service provider. For example, a home computer that the user and the user's children have access to may be designated as a public device by the user because the user may not want the children to be authenticated or have access to certain content or conduct transactions on the home computer. In an embodiment, a device is determined to be a public device if it is accessible to more than five users not residing in the same household. In an embodiment, a device is determined to be a public device if it is own by a public entity (e.g., a city government).

In an embodiment, the system 160 may create a secure key for a public device 108. The secure key may be a short-lived secure key, a one-time use secure keys with restrictions e.g., ASP limit, usage limit, and counterparty limit.

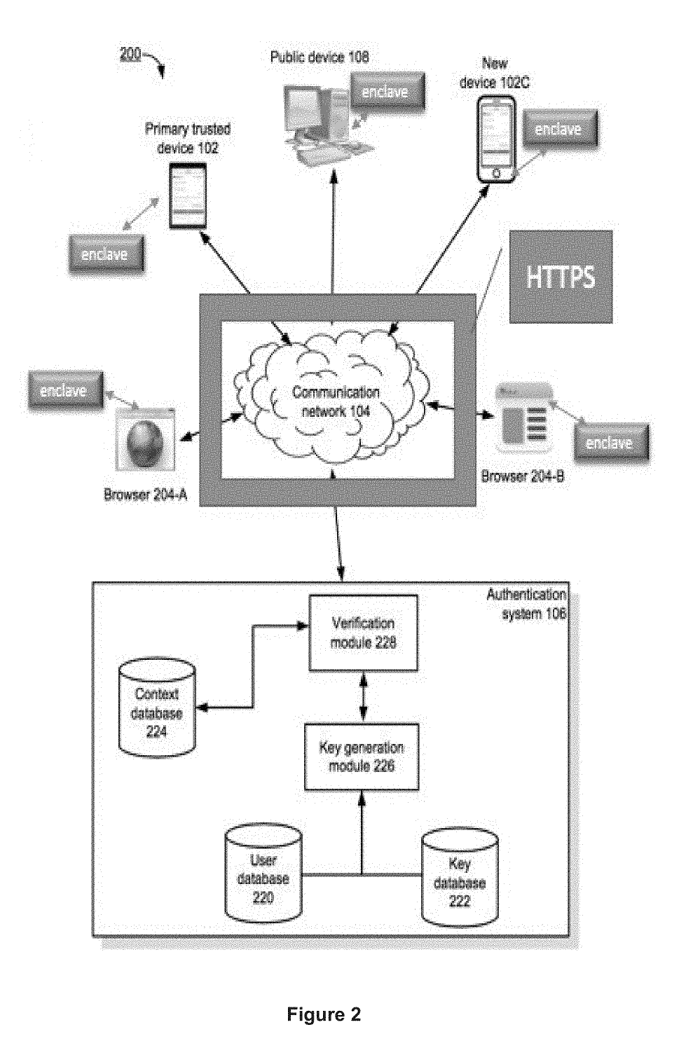

FIG. 2 is a schematic view illustrating an embodiment of a system 200 for providing a secure key based trust chain among several user devices. The system 200 may comprise or implement a plurality of servers and/or software components that operate to perform various technologies provided in the present disclosure.

As shown in FIG. 2, the system 200 may include a plurality of user devices 102 and 102C, an authentication system 106, a public device 108, one or more content viewing applications (e.g., browsers or native applications) 204A and 204B.

In an embodiment, the authentication system 106 receives a request to authenticate a user on an untrusted device (e.g., a device that does not currently have a secure key stored in its secure element, for example, the new device 102C) and transmits another request for approval to a trusted device (e.g., the primary trusted device 102). In an embodiment, responsive to a user approval of the authentication request, the authentication system 106 registers the new device 102C (in association with an identifier of the user, e.g., an application specific user identifier or a generic user identifier) as a trusted device. In an embodiment, as part of registering the new device 102C as a trusted device, the authentication system 106 stores a secure key (e.g., an encrypted password or device identifier) on the secure element of the device 102C.

In an embodiment, the authentication system 106 includes a user database 220, a key database 222, a context database 224, a key generation module 226, and a verification module 228.

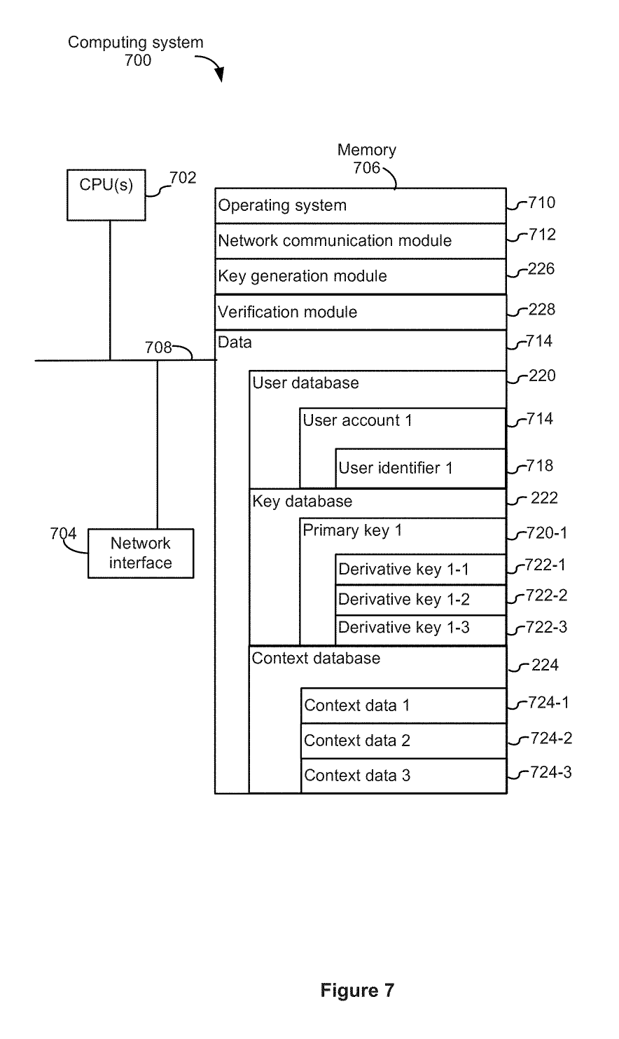

The user database 220 may store information identifying one or more user accounts (as shown in FIG. 7). A user account may include: a user identifier, a corresponding password, context data, one or more application identifiers, and one or more device identifiers.

The key database 222 may store information identifying one or more keys (e.g., primary or derivative keys). A key can be application specific, user specific, or device specific. For example, a key may help decrypt and produce a password for a specific user application; in another example, a key may be used to decrypt and produce two or more device identifiers (e.g., a primary trusted device and a secondary trusted device) for the same user. A key may be considered as a link between the application, user and device instances.

The key generation module 226 may generate one or more same or different keys for a given user identifier, after a user has successfully registered a device. In an embodiment, the key generation module 226 generates a key in accordance with a user identifier, an application identifier, a device identifier, a randomly generated Globally Unique Identifier (GUID), or any combination thereof. For example, a key may be an encrypted password for a given user identifier for logging into a given application. In another example, a key may be an encrypted device identifier that identifies a trust device.

The context database 224 may store context data identifying a user's status or progress in an application or device. For example, the context data may describe which steps of a payment transaction a user has completed and which other steps still remain (e.g., a user has completed billing address and selected payment method, but still needs to provide a shipping address and a phone number). In some embodiments, the authentication system 106 shares context data among two or more different applications, e.g., a GOOGLE CHROME browser 204-A and an APPLE SAFARI browser 204-B. Sharing context data among different applications or devices enables a user to more easily resume activity in one application what she was working on but did not complete in another application. This is particularly advantageous when these applications are running on different devices. For example, a user who was using a payment account to complete a purchase of a pair of shoes on her laptop computer can resume the purchase transaction on her smartphone while commuting to work.

The verification module 228 verifies whether a user device is a trusted device or not. When a user device is not a trusted device, the verification module 228 requests a user authentication, from a trusted device or from the user, for accessing an application on the user device. For example, if a device is not a trusted device with respect to a particular user identifier, the verification module 228 may submit a request to authenticate the user identified by the user identifier to a trusted device. For example, if a user is trying to log into a payment account on the new device 102C, the authentication system may determine that the new device 102C is not a trusted device and therefore requests a user approval on the primary trusted device 102.

FIG. 3 is a flow chart illustrating an embodiment of a method 300 for providing a secure key based trust chain among several user devices. The authentication system 106, for example, when programmed in accordance with the technologies described in the present disclosure, can perform the method 300.

In some embodiments, the first device where a user registers a user identifier (as opposed to logging into an account using an existing user identifier) is considered the primary trusted device. For example, as shown in FIG. 3, a user is registering (304) a payment account on the desktop computer 302. As part of the registration, the user may verify her identity by answering security questions (e.g., the name of her best female high school friend) or providing information uniquely identifying the user (e.g., the user's Social Security Number and Date of Birth) or confirm a phone number by sending a 1-time code. The verification system may use a plurality of methods that may or may not involve the user to ascertain whether the user is who she is claiming she is.

Upon a successful identity verification, the user can register (306) the device (e.g., the desktop computer 302) with a service provider of the payment account (e.g., the PAYPAL Inc.). In some embodiments, registering the device includes providing (310) a device identifier (e.g., an IMEI number of a phone) or other information (e.g., uniquely) identifying the device (e.g., a device name, a device's make and model, and a device version number) to the authentication system 106, which can register the device identifier in the user database 220 and generate a key based on the device identifier or the user identifier, or both.

In some embodiments, the user can, e.g., using the on-boarding process, register (308) two or more devices as trusted devices in association with a same user identifier. For example, the user can log into a payment application on the two or more devices with the same user identifier without having to provide a password.

In some embodiments, the user can register two or more devices as trusted devices in association with different user identifiers (e.g., for different application). For example, a user may register her tablet computer (that she shares with her roommate) as a trust device for the user's news feed account, but not the user's online banking account (which demands a higher level security).

This part of the device registration (e.g., steps 304-308) is sometimes referred to as the initial registration process or the on-boarding process.

Upon a successful registration, the authentication system 106 may generate a key and stores the key in a secure element of a registered user device, after which time the registered user device can become a trusted device (e.g., with respect to the user identifier).

Steps 314 and 316 describe a password-less user authentication on an untrusted (e.g., new) device 312.

To authenticate on an untrusted device, a user may use a manual registration process. For example, the user may provide the same user identifier as well as the key assigned to the device 302 to the authentication system 106. In some embodiments, a key assigned to a trusted device is an encryption code (e.g., the string “ACD999”).

Based on the same user identifier and the key, the user can then register the new device 312. Note that in this manual registration process, the new device 312 is registered without requiring the user to provide information uniquely identifying the user, unlike what was required from the user (e.g., at steps 306 and 308) during the initial registration of the primary trusted device. Once the new device 312 is successfully registered, the authentication system 106 may generate a key for the new device 312 and store the key in the secure element of the new device 312.

Alternatively, the user may use an automatic registration process. For example, upon detecting a user request to register the new device 312 under a given user identifier, the new device 312 transmits the request (e.g., including the user identifier) to the authentication system 106.

The authentication system 106, based on the user identifier provided, identifies one or more trusted devices associated with the user identifier, e.g., a primary trusted device and one or more secondary trusted devices.

The authentication system 106 then transmits, to a selected trusted device, a request for user approval of the authentication request on the new device 312. Upon obtaining a user approval from the trusted device, the authentication system 106 authenticates the user (as identified by the user identifier) on the new device 312.

Note that in this automatic password-less registration process, the new device 312 is also registered without requiring the user to provide information identifying the user, e.g., user or account credentials, the password for the user identifier or an answer to a security question. This is advantageous, as the user can complete user authentication on the new device with less effort, e.g., without having to provide, on a POS machine, a full user name and the corresponding password for accessing a payment account to pay a merchant, as well as with less risk (e.g., greater security), as private user information (e.g., a user password) was not required from the user.

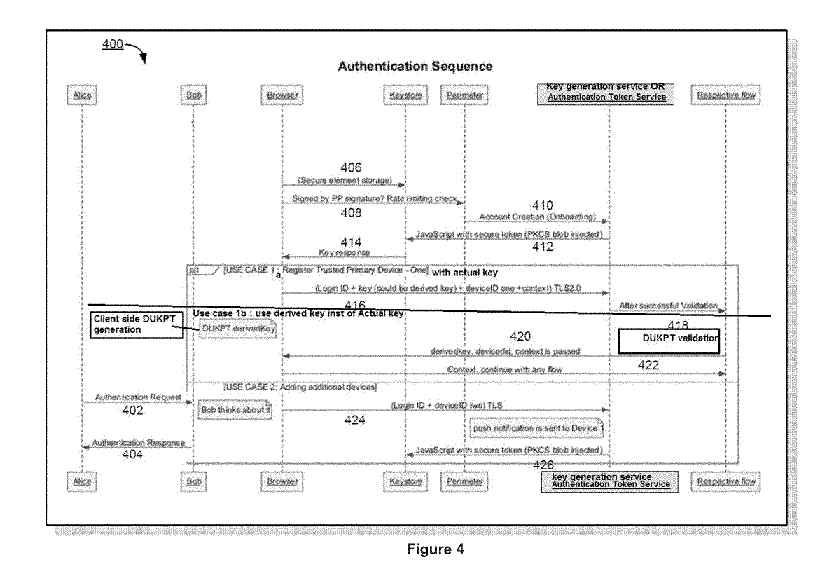

FIG. 4 is a flow chart illustrating an embodiment of a method 400 for providing a secure key based trust chain among several user devices. The system 108, for example, when programmed in accordance with the technologies described in the present disclosure, can perform the method 400.

In some implementations, the method 400 includes requesting a second user on a second device to authenticate a first user on a first device (different from the second device). For example, user Alice and user Bob may share the same user name for a payment account, e.g., because they are husband and wife.

Therefore, when user Alice tries to log into the payment account on her smartphone (which is not a trusted device with respect to the payment account), user Bob receives a message 402 asking him to either approve or deny Alice's request to authenticate herself for logging into the payment account. User Bob can send a response 404 to approve user Alice's login request.

In some implementations, two applications (e.g., a browser A and a browser B) running on a same computing device can be considered as two separate devices, for the purpose of user authentication. For example, when the browsers A and B communicate with the authentication system using (1) different individual sessions and do not (or not able to) share a session ID with each other or (2) different communication secure keys, the authentication system may treat the browsers A and B as different devices, e.g., even though browsers A and B are running on a same laptop computer.

In these implementations, each browser may have its own key stored (406) in the secure element of the user device. A key store is, in some embodiments, a storage area within the secure element for storing one or more keys in association with each other, with a given user identifier, with a given device identifier, or with any combination thereof. In some implementations, a key store stores a subset of keys stored in the key database 222. A key store therefore is sometimes referred to as a local key database.

Steps 408-414 describe how a user may, in a browser environment, register a trusted device, using a process similar to that for registering a user device (e.g., 304-310), as described with reference to FIG. 3.

Steps 416-422 describe (1) how context data can be shared between applications (e.g., from a first browser to a second smartphone app and vice versa) and (2) after receiving updated context data from one application, how to continue user progress in the other application based on the updated context data.

For example, a user may, after logging in to an online payment account, place five items in a shopping cart using a GOOGLE CHROME browser on her smartphone while commuting to home. After arriving home, the user can log into the payment account in her home computer's APPLE SAFARI browser and continue the checkout process for the five items she placed in the shopping cart earlier. For example, the user may complete the billing address as well as the payment information and complete the transaction using the SAFARI browser on her home computer.

Here, the context data (e.g., which items have been placed in the shopping cart and that the user was in the middle of a check-out process) is passed from the GOOGLE CHROME browser on the user's smartphone to the APPLE SAFARI browser on the user's home computer—through an authentication system associated with the user's payment account.

Note that, in some embodiments, context data is passed between different devices after these devices are considered trusted devices of the user. In these embodiments, context data is accompanied by keys when passed between different devices or applications. Because these keys (the same primary key or one primary key with many secondary keys) can uniquely identify the user name for the payment account, the user can access the payment account.

Also note that accompanying data communications between a user device and the authentication system with a key can enable a secure key-based authentication between the user device and the authentication system. These technologies can therefore reduce the need for session-based communications between the user device and the authentication system. This is technically advantageous, as the session-based communications are more susceptible to unauthorized access (e.g., a session ID hijacking) (resulting in improved data security) and the authentication system is not required to maintain a large number of session IDs, as required in session-based communications.

Steps 424-426 describe how a new (and thus untrusted) device may be registered as a trusted device associated with a user login, without requiring a user to provide a corresponding password, in a manner similar to that for registering a second new device (e.g., steps 312-314), as described with reference to FIG. 3.

Stated in a different way, at step 406, a browser may accesses a Secure Key (SK) in the secure element. At step 480, different actions may be taken based on the SK check at step 460.

If the device on which the browser is executing has no secure key (SK) present in its secure element, then the browser may initiate a request to the authentication server with all the signup credentials.

These credentials may be provided to the Key Generation Service (KGS) to generate SK and transmits the SK back to the browser. The browser may store the SK in the secure element on the device on which the browser is executing. The SK may be stored in association with the corresponding public login credentials (e.g., the username).

If the device on which the browser is executing has a corresponding SK present in its secure element, the browser sends the SK with the context data to the server. The login credentials are validated at the KGS, and the context is passed on to the business flows to render the page based on the context.

The user then continues with the authenticated business flow. If the SK is present and a user would like to switch user login (e.g., by selecting the “Not you, Bob?” link), the SK will be retrieved based on the public credential of the new user.

If the device is brand new out of the box, the user will register this device by providing the user credentials.

A push notification (PN) will be sent to the trusted primary device (TPD). The user then confirms the registry of the new device from the TPD. The server now pushes the corresponding SK for the TPD into the ND. Now the ND is ready for a passwordless experience.

At step 410, the system can onboard the user based on the checks at step 408.

If the device on which the browser is executing has no secure key (SK) present in its secure element, an account may be created. The SK may be stored in the device's secure element. Alternatively, if the device on which the browser is executing has no secure key (SK) present in its secure element, various different actions may be taken.

If the SK is present and the user is requesting to switch to a different user login (e.g., by selecting the “Not you, Bob?” link), the respective user is taken to the different work low based on the context.

If the device is brand new out of the box, then a PN is sent to the TPD. At step 412, a key validation or generation is carried out.

If SK is present, then SK may be validated by Key Management service (KMS); if SK is not present, then SK may be generated by KMS and transmitted back to the browser (or app). The browser (or app) then uses the API to store the SK in the secure element of the device.

At step 414, the key store may respond to the browser/app on a successful storage of the SK. At step 416, the user ID, the SK, the device ID, the application context data are passed to the KMS for storage.

Steps 418-420 describe a similar implementation of the above methods, but with a derived key of the actual key. The derived key can be unique in each transaction.

After the SK is validated, authentication system may take various actions depending in the context.

Steps 424-426 describe registering additional devices. For example, at step 424, a new device may be registered using a login ID and a device ID; at step 426, a PN is sent to the primary trusted device to authenticate the new device. The same process described at steps 406-408 may be followed for saving and restoring context data on a new device.

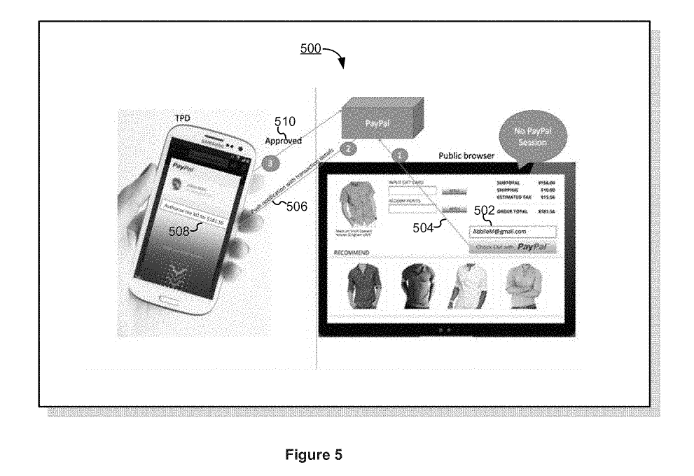

FIG. 5 is a schematic view illustrating an embodiment of a method 500 for authorizing, though a trusted device, a transaction being conducted on an untrusted device (e.g., a new device or a public device). The user device 102, for example, when programmed in accordance with the technologies described in the present disclosure, can perform the method 500.

As shown in FIG. 5, when a user is conducting a transaction on a public device (e.g., a POS device or a public computer), the authentication system 106 may not find a key corresponding to the user identifier 502 present on the public device, because as explained in other parts of the present disclosure, the authentication system 106 may not store keys on public devices.

After not being able to locate the corresponding key (e.g., the key corresponding to the PAYPAL account user name AbblleM@gmail.com), the authentication system obtains (504) the user identifier 502 from the public device. The authentication system then determines a trusted device (e.g., a primary trusted device or a second trusted device) associated with the user identifier 502 and transmits (506) a request to authenticate the user (as identified by the user identifier 502) on the public device, to the trusted device.

As shown in FIG. 5, the request 508 may include presenting the user's name (e.g., “XO”) or the user login name (e.g., “AbblleM@gmail.com”) as originally provided on the public device, as well as the amount being transacted (e.g., “$181.56”). A user can approve (510) the request on the trusted device, which enables the transaction on the public device to go through.

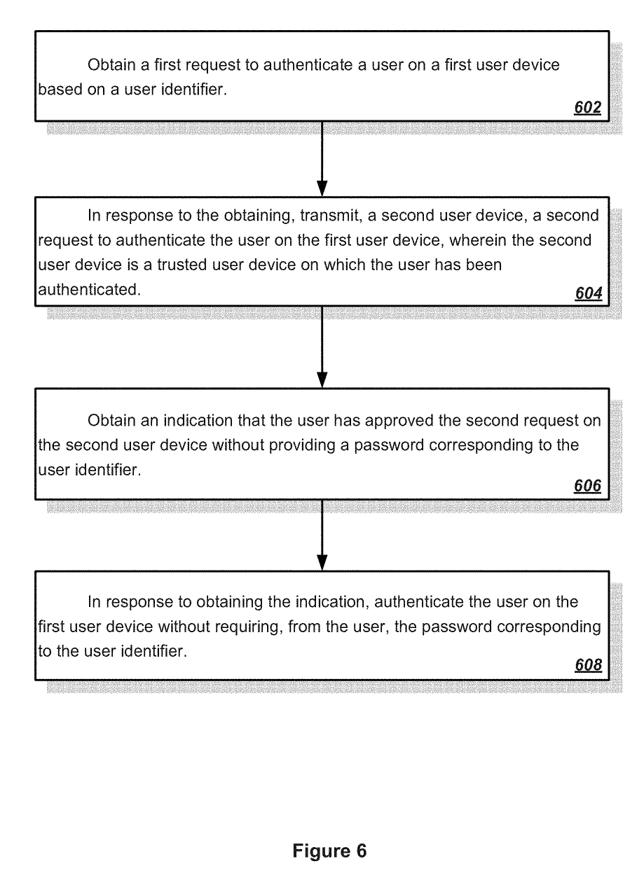

FIG. 6 is a flow chart illustrating an embodiment of a method 600 for providing a secure key based trust chain among several user devices. The authentication system 106, for example, when programmed in accordance with the technologies described in the present disclosure, can perform the method 600.

In some embodiments, the method 600 includes obtaining (602) a first request to authenticate a user on a first user device based on a user identifier.

In some embodiments, the method 600 further includes, in response to the obtaining, transmitting to (604), a second user device, a second request to authenticate the user on the first user device.

In some embodiments, the authentication system transmits the second request to the second user device, because the second user device has been deemed a trusted device of the user, e.g., using the on-boarding process described with reference to FIG. 3.

In some embodiments, the method 600 optionally performs an on-boarding process on the second user device, which includes in response to authenticating the user on the second user device, storing a second secure key within a hardware secure element of the second user device.

For example, during an on-boarding process for a user device, after a user has passed a predefined number of identity challenges, the authentication system determines the user device is a trusted device. In accordance with this determination, the authentication system stores a key (e.g., a primary key) within the secure element of the user device.

In some embodiments, the method 600 also includes obtaining (606) an indication that the user has approved the second request on the second user device without providing a password corresponding to the user identifier. For example, when a user is approving a request to authenticate the user on an untrusted device, the user does not need to provide a password even on the trusted device (the device on which the request for approval is being processed). This is because a trusted device already has a key stored in its secure element, and the authentication system can automatically detect the presence of the key and thus does not require the user to provide a password.

The method 600 also includes, in response to obtaining the indication, authenticating (608) the user on the first user device without requiring, from the user, the password corresponding to the user identifier. For example, because the user has already approved the authentication request on the trusted device, the authentication system automatically authenticates the user (or a different user) on the first user device and may convert the first user device into an additional trusted device, e.g., when the first device is not a public device.

In some embodiments, the authentication system determines whether a device is a public device based on an address (e.g., the IP address or a physical address) associated with the device. For example, if a computer has an IP address belonging to a public university, then the authentication system may deem the computer a public device. For example, if a computer is identified as physically located inside a city-own public library or a grocery store, then the authentication system may deem the computer a public device.

In some embodiments, the method 600 optionally includes: in response to obtaining the indication, generating (610) a first secure key based on a device identifier of the first user device; and storing the first secure key on the first user device. For example, once a user device is deemed a trusted device, the authentication system may apply one or more encryption algorithms on the device identifier (and optionally on the user identifier) to produce the first secure key. The one or more encryption algorithms may include symmetric algorithms or asymmetric algorithm. The one or more encryption algorithms may include the triple DES algorithm, the RSA algorithm, the blowfish algorithm, the two fish algorithm, and the AES algorithm.

When there are several trusted devices, the trusted device to which the request to authenticate the user on the first user device is sent may be selected dynamically based on one or more criteria, e.g., a trusted device's availability, location, battery level, network connection status, and the like. In some embodiments, therefore, the method 600 optionally includes: selecting the second user device as a primary trusted device from a plurality of trusted user devices. In some implementations, user authentication can be approved by a user through any trusted devices.

In some embodiments, the trusted device is selected based on its proximity (or lack thereof) to the first user device. For example, if first user device is a POS machine, the authentication system may determine that the user is at a merchant location trying to conduct a transaction and that the user's smartphone is also located within the merchant location (as determined by the smartphone's GPS location). Based on these determinations, the authentication system may therefore select the user's smartphone (as opposed to her personal desktop computer at home) as the trusted device.

In some embodiments, the trusted device is selected based on network connection information. For example, if the first user device is a public computer at a public library (as identified by the first user device's IP address), and the user's tablet (which is a trusted device) has wireless connected to a local computer network available at the public library, the authentication system may select the user's tablet (as opposed to her smartphone which is connected to a cellular network) as the trusted device, because the authentication request may be transmitted to the user's tablet within the local computer network with less transmission delay.

In some embodiments, a key hierarchy is provided. In some embodiments, therefore, the first secure key is generated further based on the second secure key associated with the second user device. For example, because the second user device may be considered the primary trusted device and the first computer device may be considered a secondary trusted device, the first user device may have a derivative key (derived and different from the primary key held by the second user device) that can authenticate the user on the first user device.

Implementing a key hierarchy (e.g., a primary key with one or more corresponding secondary keys) is technically advantageous, because when a key is compromised, the authentication system may disable the compromised key alone, without having to modify other keys, reducing the amount of interruption to the existing chain of trusted devices, as well as saving computing power.

In some embodiments, the trusted device includes a key management, which may (i) disable specific keys/all keys, (ii) delete specific keys/all keys, and (iii) pause and resume specific keys/all keys.

In some embodiments, the password-less authentication is triggered when a user is attempting to login on a public computer. For example, the method 600 may be performed in response to determining that the first user device is a public computing device. In some implementations, user authentication is approved by a user on a trusted device; the user is therefore not required to provide private information on a public device (e.g., a computer in a public library), reducing the risk for security compromise (e.g., improving electronic security).

In some embodiments, a method for passing context data between different trusted devices is provided.

The method may include obtaining a first request to authenticate a user on a first content viewing application executing on a first user device based on a user identifier, and
in response to the obtaining, transmitting to, a second user device, a second request to authenticate the user on the first user device. The second user device is a trusted user device on which the user has been authenticated.

The method may further include obtaining an indication that the user has approved the second request on the second user device without providing a password corresponding to the user identifier; and in response to obtaining the indication, obtaining context data descriptive of information being presented to the user in a second content viewing application; authenticating the user on the first content viewing application; and providing the context data to the first content viewing application to enable presentation of the information to the user in the first content viewing application.

In some embodiments, the method optionally includes: selecting a trusted verification method from a plurality of trusted verification methods; and in response to selecting the trusted verification method, transmitting the second request to the second user device.

In some embodiments, the first content viewing application and the second content viewing application include a first browser and a second browser, respectively.

In some embodiments, the context data identify a particular stage of transaction the user is conducting on the second user device.

FIG. 7 is a schematic view illustrating an embodiment of a computing system 700, which can be the authentication system 106 shown in FIG. 1. The system 700 in some implementations includes one or more processing units CPU(s) 702 (also referred to as hardware processors), one or more network interfaces 704, a memory 706, and one or more communication buses 708 for interconnecting these components. The communication buses 708 optionally include circuitry (sometimes called a chipset) that interconnects and controls communications between system components. The memory 706 typically includes high-speed random access memory, such as DRAM, SRAM, DDR RAM or other random access solid state memory devices; and optionally includes non-volatile memory, such as one or more magnetic disk storage devices, optical disk storage devices, flash memory devices, or other non-volatile solid state storage devices. The memory 706 optionally includes one or more storage devices remotely located from the CPU(s) 702. The memory 706, or alternatively the non-volatile memory device(s) within the memory 706, comprises a non-transitory computer readable storage medium. In some implementations, the memory 706 or alternatively the non-transitory computer readable storage medium stores the following programs, modules and data structures, or a subset thereof:
an operating system 710, which includes procedures for handling various basic system services and for performing hardware dependent tasks;
a network communication module (or instructions) 712 for connecting the system 700 with other devices (e.g., a trusted user device, an untrusted user device, a public device, or a merchant device) via one or more network interfaces 704;
a key generation module 226 for generating or obtaining one or more keys based on a user identifier, a device identifier, an application identifier, or any combination thereof;
a verification module 226 for verifying whether a device is trusted device or not, e.g., based on whether a corresponding key can be located on the device; and
data 714 stored on the system 700, which may include a device database, a risk databases, as well as the following components:
   a user database 162 for storing information identifying one or more user accounts 714, each of which may be associated with a corresponding user identifier 718;
   a key database 222 for storing a primary key 720-1 and optionally one or more secondary keys 722-1, 722-2, and 722-3 in association with the primary key; and
   a context database 224 for storing application- or device-specific context data, e.g., 724-1, 724-2, and 724-3.

In some implementations, one or more of the above identified elements are stored in one or more of the previously mentioned memory devices, and correspond to a set of instructions for performing a function described above. The above identified modules or programs (e.g., sets of instructions) need not be implemented as separate software programs, procedures or modules, and thus various subsets of these modules may be combined or otherwise re-arranged in various implementations. In some implementations, the memory 706 optionally stores a subset of the modules and data structures identified above. Furthermore, the memory 706 may store additional modules and data structures not described above.

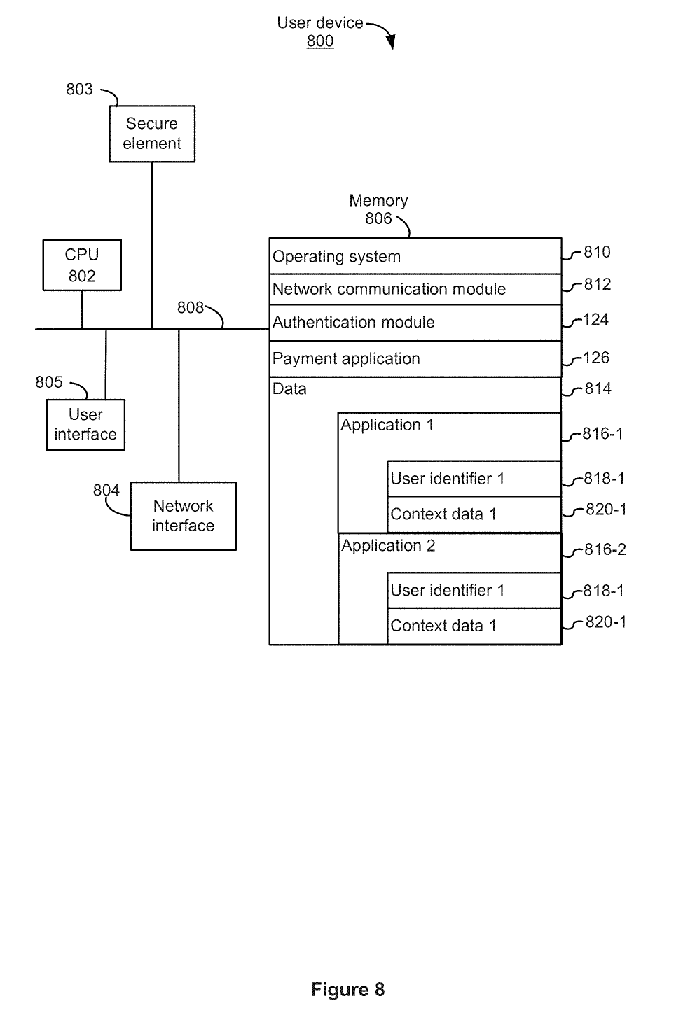

FIG. 8 is a schematic view illustrating an embodiment of a user device 800, which can be the 102 shown in FIG. 1. The device 800 in some implementations includes one or more processing units CPU(s) 802 (also referred to as hardware processors), one or more secured elements 803, one or more network interfaces 804, a user interface 805, a memory 808, and one or more communication buses 808 for interconnecting these components. The communication buses 808 optionally include circuitry (sometimes called a chipset) that interconnects and controls communications between system components. The memory 808 typically includes high-speed random access memory, such as DRAM, SRAM, DDR RAM or other random access solid state memory devices; and optionally includes non-volatile memory, such as one or more magnetic disk storage devices, optical disk storage devices, flash memory devices, or other non-volatile solid state storage devices. The memory 808 optionally includes one or more storage devices remotely located from the CPU(s) 802. The memory 808, or alternatively the non-volatile memory device(s) within the memory 808, comprises a non-transitory computer readable storage medium. In some implementations, the memory 808 or alternatively the non-transitory computer readable storage medium stores the following programs, modules and data structures, or a subset thereof:
an operating system 810, which includes procedures for handling various basic system services and for performing hardware dependent tasks;
a network communication module (or instructions) 812 for connecting the device 800 with other devices (e.g., the new device 102C, the public device 108, and the authentication system 106) via one or more network interfaces 804 (wired or wireless) or via the communication network 104 (FIG. 1);
an authentication module 124 for determining which user authentication methods are required based on whether a corresponding key can be located on the user device or not;
a payment application 126 for conducting transactions with (e.g., sending a payment to or receiving a payment from) a merchant device or another user device;
data 814 stored on the device 800, which may include:
   an application (e.g., a browser) 816-1 running on the user device 600 under the user identifier 818-1 with context data 820-1; and
   a different application (e.g., a different type of browser) 816-2 running on the user device 600 also under the user identifier 818-1 and with context data 820-1.

The one or more secured elements 803 may storage one or more keys (e.g., a primary key and one or more derivative keys). The device 800 may further include a location determination component (e.g., a Global Positioning System (GPS) device and a cell tower triangulation device) for providing location information of the device 800.

In some implementations, one or more of the above identified elements are stored in one or more of the previously mentioned memory devices, and correspond to a set of instructions for performing a function described above. The above identified modules or programs (e.g., sets of instructions) need not be implemented as separate software programs, procedures or modules, and thus various subsets of these modules may be combined or otherwise re-arranged in various implementations. In some implementations, the memory 808 optionally stores a subset of the modules and data structures identified above. Furthermore, the memory 808 may store additional modules and data structures not described above.

Although FIGS. 7 and 8 show a “computing system 700” and a “device 800,” respectively, FIGS. 7 and 8 are intended more as functional description of the various features which may be present in computer systems than as a structural schematic of the implementations described herein. In practice, and as recognized by those of ordinary skill in the art, items shown separately could be combined and some items could be separated.

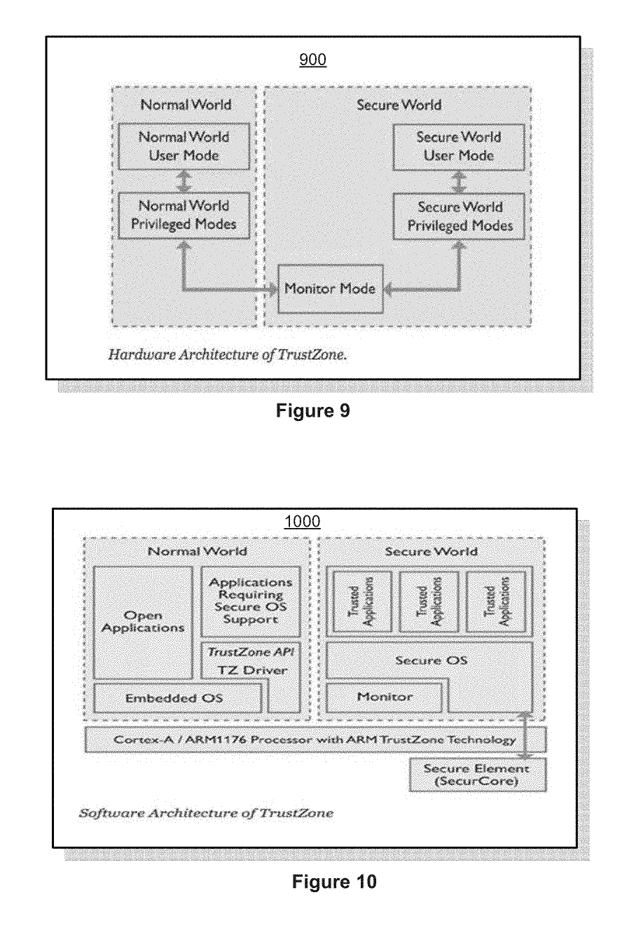

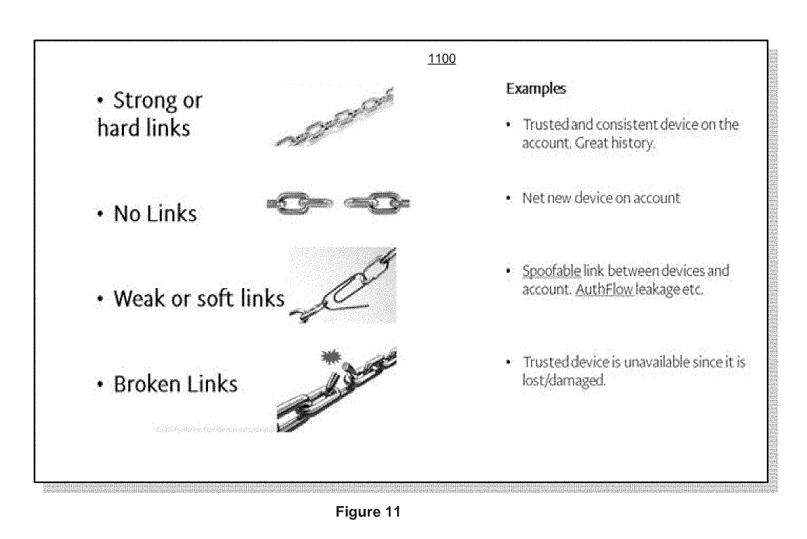

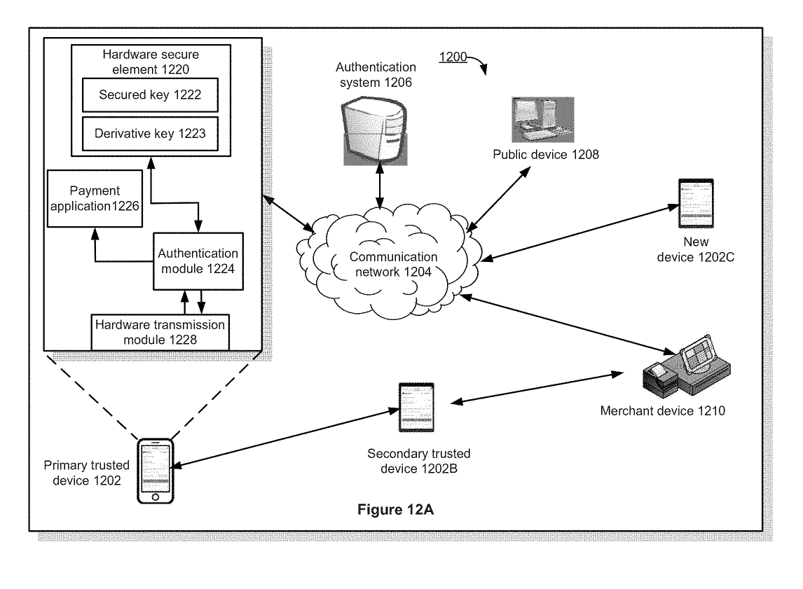

FIG. 9 is a schematic view illustrating an embodiment of a hardware architecture of a trust zone 900; FIG. 10 is a schematic view illustrating an embodiment of a software architecture of a trust zone 1000; FIG. 11 is a schematic view illustrating various models for a trust chain 1100. Different chain types can be applied to the various trust chains described in the present disclosure.

The present disclosure, in another set of embodiments, provides systems and methods for transmitting user data (e.g., user credential, authorization permissions, use restrictions) among multiple devices. The term ‘user’ may refer to a customer entity often represented by a unique account on the provider platform, e.g., individual or household entity, business entity, organizational entity.

In one implementation, a user may use her primary trusted user device to search for other devices physically present within a predefined proximity (e.g., 10 feet) to the primary trusted device. For example, the primary trusted user device may activate its Bluetooth Low Energy (BLE) communication module to request other user devices within the predefined proximity to accept a connection with the primary trusted device. The user may then select, on the primary trusted user device, which detected user devices she would like to entrust—by transmitting a user credential (or a modified credential) from the primary trusted user device to one or more of the detected user devices. The user can then log into a same account that she has logged into on the primary trusted user device without having to provide a user name-password pair or other authenticating credential. Other short-range communication modules, e.g., an NFC communication module or an RFID communication module, may also be used. As a result, a user can entrust multiple nearby user device and enable password-less authentication thereon with less effort than conventional means.

The systems and methods described in these embodiments can provide a variety of technical advantages.

First, manual password input can be reduced or eliminated, because a user can be authenticated through encrypted user credentials (e.g., secure keys) stored on her devices, without having to manually provide a password for login purposes.

Second, trust chains linking different user device can be established with minimal user interactions. For example, a primary trusted device can actively seek out nearby devices and, upon a successful connection, enable password-less logins on those devices.

Third, power consumption can be lowered and device service time can therefore be increased without requiring frequent power charges. A trusted user device may use low energy consumption communication protocols (e.g., a BLE-based protocol) to actively detect other devices (to which user credentials may be transmitted and on which password-less logins can be enabled); the other devices may passively wait for connections by a trusted user device and switch to an increased power consumption mode to enable data transmission after successfully connected with the trusted user device.

Fourth, after an initial linking of devices establishing trust, fraudulent transactions can be detected when user devices are linked using a trust chain. For example, if two trusted devices of a user are transacting from different locations (e.g., New York City in the State of New York and San Francisco in the State of California, which are approximately 3,000 miles from each other) at the same time, the system may consider one of these two transactions as not belonging to the user and, as a result, deny the transaction.

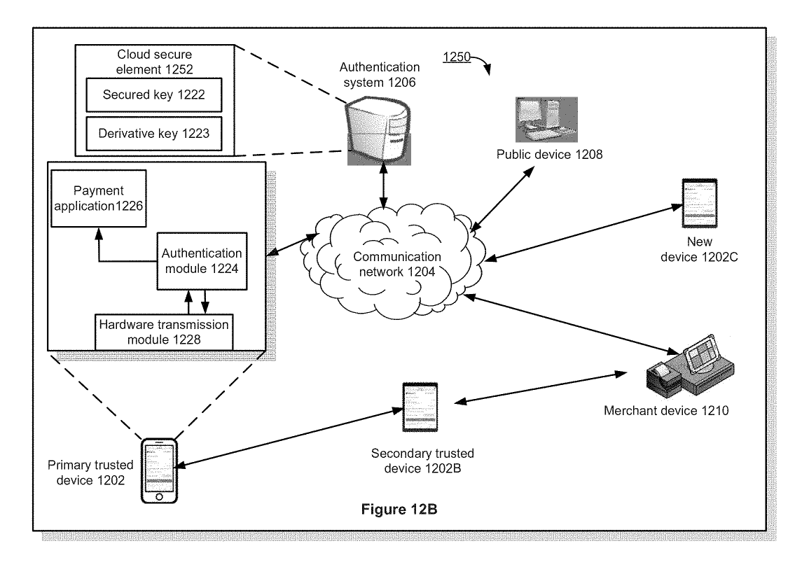

Additional details of implementations are now described in relation to FIGS. 12-16.

FIG. 12 is a schematic view illustrating an embodiment of a system 1200 for transmitting user data among user devices. The system 1200 may comprise or implement a plurality of servers and/or software components that operate to perform various technologies provided in the present disclosure.

As illustrated in FIG. 12, the system 1200 may include a plurality of user devices (e.g., 1202, 1202B, and 1202C), an authentication system 1206, a public device 1208, and a merchant device (e.g., a POS device) 1210 in communication over a communication network 1204.

In one embodiment, the user device 1202 may enable a user to authenticate herself on the device and to, after a successful authentication, conduct a transaction with the merchant device 1210, for example, via a short-range communication channel (e.g., a BLE-based or NFC-based communication channel) or the communication network 1204.

In some embodiments, the device 1202 may include a secure element 1220, an authentication module 1224, a payment application 1226, and a hardware transmission module 1228. The user device 1202 may be implemented as a wearable device, a smart-home appliance, a smart phone, a tablet computer, a laptop computer, a personal computer, or other computing devices.

The secure element 1220 includes a hardware storage area for storing private data—such as a digital identification (ID) or a password of a user—in such a way that it is difficult to compromise (e.g., with multiple levels of encryptions or access restrictions). For example, a secure element of a device may be located in a Universal Integrated Circuit Card (UICC), a Subscriber Identity Module (SIM) card, Secure Data (SD) card or embedded Secure Element (eSE), any of which may be plugged into or otherwise connected with a user device.

In some embodiments, the secure element 1220 stores one or more secure keys identifying one or more user login identifiers, e.g., a user name for an email application, a user name for a payment application, and a user name for a ride-sharing application. The one or more keys may include a primary key 1222 and optionally one or more derivative keys 1223. Technologies relating to key generation, storage, and verification are explained in greater detail in U.S. patent application Ser. No. 15/193,487.

In some embodiments, the user device 1202 includes an authentication module 1224 which may be used to authenticate a user on the user device 1202. In some embodiments, the authentication application 1224 may determine whether to authenticate a user on the user device based on a secure key stored in the secure element 1202, without asking a user to provide a password. An application level authentication is provided in some implementations. For example, after receiving a user's login identifier for the payment application 1226, the authentication module 1224 may search for a corresponding key in the secure element 1220. If the authentication module 1224 finds the corresponding key in the secure element 1220, the authentication module 1224 may determine the user authenticated on the device 1202, e.g., for the purpose of accessing the payment application 1226. The authentication module can be a part of the device 1202 or the payment app 1226 or any other app or a free standing authentication app on the device 1202.

A device level authentication is provided in some other implementations. For another example, after receiving a user's fingerprint or other authenticating data on the user device 1202, the authentication module 1224 may search for a corresponding key in the secure element 1220. If the authentication module 1224 finds the corresponding key in the secure element 1220, the authentication module 1224 may determine the user authenticated on the device 1202 for the purpose of accessing at least one app currently installed on the device 1202. In one embodiment, user access is granted on all apps or selected subset of apps installed on the device 1202.

In one alternative embodiment, the authentication module 1224 may collect credentials from a user and compare the collected credentials with previously accepted credentials to decide whether to authenticate a user. For example, the authentication module 1224 may (1) collect, from a user, a user or device identifier such as an email address, device ID, user name, a password or PIN, an audio/video fingerprint, biometric data (e.g., voice, fingerprint, gesture), or other credential information, (2) match credential information to previously accepted or stored credential information, and (3) authenticate the user when a match occurs.

In one other alternative embodiment, the authentication module 1224 may authenticate a user using technologies like Fast-Identity Online (FIDO). The password-less FIDO technology is supported by the Universal Authentication Framework (UAF) protocol. In some embodiments, a user registers her device to the online service by selecting a local authentication mechanism such as swiping a finger, looking at a camera, speaking into a microphone, entering a PIN, etc. The UAF protocol allows the service to select which mechanisms are presented to the user.

The second factor FIDO technology is supported by the Universal Second Factor (U2F) protocol. This technology allows online services to augment the security of their existing password infrastructure by adding a strong second factor to user login. The user logs in with a usemame and password as before. The service can also prompt the user to present a second factor device at any time it chooses. The strong second factor allows the service to simplify its passwords (e.g. 4-digit PIN) without compromising security.

In some embodiments, a device 1202 uses an alternative data storage element that is as secure as the secure element, when the secure element is not available, for example, when it may be not feasible to install a secure hardware element on the device. The alternative data storage element may be a software program that encrypts user credentials.

As shown in FIG. 12B, in some embodiments, the alternative data storage element may include a cloud secure element 1252. The cloud secure element 1252 may be hosted in the cloud, for example, like the Hosted Card Emulation (HCE) in the Android mobile operating system. In these embodiments, the authentication system 1206 may include a computing cloud that provides shared computer processing and data storage resources to computers and other devices on demand.

The payment application 1226 may be used, for example, to initiate a payment from a user account (e.g., maintained by a payment service system) to a payee (e.g., a merchant device or another user device) over the communication network 1204. The payment application 1226 may be implemented as a smartphone app or a web browser. The device 1202 may also include other apps, e.g., a lunch app, a ride-sharing app, a messaging app, and a map app. The payment application 1226 can also be implemented as a Software Development Kit (SDK) integrated into these other apps.

The hardware transmission module 1228 may initiate communications with other user devices and respond to requests to connect or requests to transmit data initiated by the other user device. The hardware transmission module 1228 may implement one or more communication protocols to communicate with other user device, for example, a Bluetooth-based protocol, a BLE-based protocol, a ZigBee-based protocol, a Z-Wave-based protocol, a 6LoWPAN-based protocol, an RFID-based protocol, a Wi-Fi-based protocol, and an NFC-based protocol.

For example, a primary trusted user device may, while maintaining itself in a low power consumption mode, broadcast requests to connect (RTC) towards one or more predefined directions or locations; a user device, upon receiving a RTC, may wake itself up (e.g., switching form a lower power consumption mode to a higher power consumption mode) and communicate with the primary trusted user device to transmit data therewith.

In some embodiments, a user device 1202 is considered a trusted device after a user registers the user device 1202 with a service provider. The registration process is also referred to as a device on-boarding process in the present disclosure. For example, after meeting a predefined number of authentication criteria, a user can register, with a payment service provider, a device identifier (e.g., a phone number or an IMEI number or any globally unique identifier or universally unique identifier (GUID/UUID)—generated by the service provider's services and installed on either the target app on a device, the device or the cloud (like the aforementioned HCE) and/or the corresponding server) that identifies a user device 1202. After a successful on-boarding process, the service provider may generate a key based on the device identifier, a user identifier, or both, and store the key in a secure element of the user device 1202.

In some embodiments, a user may have two or more trusted devices, e.g., the primary trusted device 1202 and the secondary trusted device 1202B. A primary trusted device may be the first device that a user registered with a service provider, a second trusted device may be a device that the user registered with the service provider after the primary device is registered. In some implementation, a request for user confirmation is presented on the primary trusted device, when a new device is being on-boarded as another trusted device.

In some implementations, the communication network 1204 communicatively interconnects one or more of the user devices 1202 with each other, with the authentication system 1206, and/or with a public device 1208. In some implementations, the communication network 1204 optionally includes the Internet, one or more local area networks (LANs), one or more wide area networks (WANs), other types of networks, or a combination of such networks.

In an embodiment, the authentication system 1206 authenticates a user on one or more user devices by (1) forwarding an authentication request on a new user device (which is also referred to as an untrusted device) to a trusted device for user approval (or denial), and (2) when the request is approved, authenticating the user on the new user device. The authentication system 1206 may additionally generate and store a secure key on the new user device, after which the new user device can become a trusted device.

In an embodiment, the public device 1208 includes a device that is accessible to the general public or to more than a predefined number of users who are not related to each other within a predefined degree of connections, e.g., strangers rather than family members. For example, the public device 1208 may be a computer in a public library or a school computer lab. In an embodiment, upon determining that a device includes a public device, the authentication system 1206 refrains from storing a key on the device, because storing the key on a public device, even in an encrypted form, may increase of the risk of jeopardizing private user information. In some embodiments, therefore, a public device is not deemed a trusted device by the authentication 1206, regardless the frequency of user logins from the public device. In another embodiment, whether a device is public may be defined by the user and/or the service provider. For example, a home computer that the user and the user's children have access to may be designated as a public device by the user because the user may not want the children to be authenticated or have access to certain content or conduct transactions on the home computer. In an embodiment, a device is determined to be a public device if it is accessible to more than a predetermined number of users (e.g., five users) not residing in the same household. In an embodiment, a device is determined to be a public device if it is own by a public entity (e.g., a city government) or a private entity managing public services (e.g. a Fedex/Kinko's copying services or an Airlines ticketing and check-in Kiosk.

In an embodiment, the authentication system 1206 may create a secure key for a public device 1208. The secure key may be a short-lived secure key, a one-time use secure keys with restrictions e.g., Active Server Pages (ASP) limit, usage limit, and counterparty limit.

A dashboard feature may be provided in various embodiments. For example, a dashboard app installed on a trusted device may present to a user information identifying which devices have been identified as trusted devices, the relationships between the trusted devices (e.g., which device is the primary trusted device), which devices are being on-boarded and awaiting user confirmation, as well as logistical or system information of these device, e.g., present locations, IP addresses, operating systems, and power consumption levels. The app may also allow the user to configure which of these devices presented are to be enabled for which trusted services. For example, some devices may be enabled for both password-less login and password-less payments, which others may be restricted to password-less logins but not password-less payments. In this latter case, the user can only view past historical transactions, but may not be able to initiate payments transactions.

In some implementations, a graphical rendition of the proximity based devices is presented to a user. For example, when a primary trusted device detects a total of five user devices within 10 feet of the primary trusted device, the dashboard may present, to a user, the relative location or directions of these detected user devices (to the location of the primary trusted device). When a user selects one of the detected user devices for the purpose of transmitting the user credential, the dashboard may visualize the user credential transmission process, e.g., by displaying which detected user devices are receiving the user credential, which user devices have already received the user credential, and which detected user devices are not allowed to receive the user credential. In some implementations, the dashboard also presents one or more of the following information items for easier user identification, e.g., the names of the detected devices, the proximities of these devices to the primary trusted device (to scale or not to scale). By providing such a visualization feature, a user can visualize which eligible user devices exactly she is committing to an authorization.

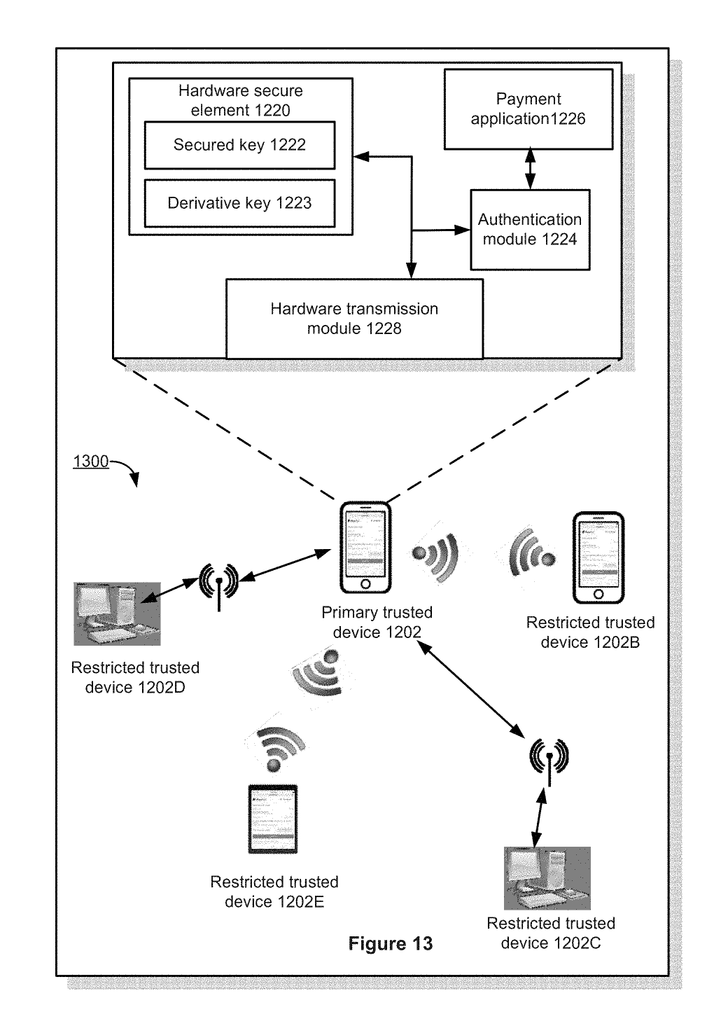

FIG. 13 is a schematic view illustrating an embodiment of a system 1300 for transmitting user data among user devices. The system 1300 may comprise or implement a plurality of servers and/or software components that operate to perform various technologies provided in the present disclosure.

As illustrated in FIG. 13, the system 1300 may include a plurality of devices, for example, a primary trusted device 1202 and one or more restricted trusted devices 1202B-1202E, in communication with each other over using one or more short-range communication channels. For example, the primary trusted device 1202 may, using the hardware transmission module 1228, to establish BLE-based or NFC-based communication channels with a restricted trusted device.

In an embodiment, a restricted trusted device includes a user device that can be entrusted with storing—and conducting transactions based on—a user credential (or a modified version thereof). A use restriction, in an embodiment, includes a set of permission based constraints that are authorized by the user on her devices. A restricted trusted device may have use restrictions imposed on the type of transactions it may conduct with a user credential.

For example, a parent may designate her middle school daughter's smartphone as a trusted device for the limited purpose of purchasing grocery items from a nearby grocery store (as opposed to buying video gaming devices from an online store) by transmitting her user credential for a payment application to her daughter's smartphone and restricting the use of the user credential on the children's smartphones to (1) purchasing grocery items (e.g., vegetable, milk, and eggs) and (2) from a nearby grocery store (e.g., a SHOPRIGHT or SAFEWAY store within 5 miles of their home. As another example, an engineering team leader may designate her three team members' smartphones as trusted devices for the limited purpose of buying a single lunch under twenty dollars within one day after the team leader transmits her payment app credential to the team members' smartphones.

A (primary or second) trusted device may wirelessly revoke trust previously given to a restricted trusted device through a communication protocol/channel different from the original communication protocol/channel through which the user credential was transmitted to the restricted trusted device. To continue with the mother-daughter example above, the mother, after transmitting, through a BLE connection (or any other short-range wireless connections), her payment credential to her daughter's smartphone, may request to remove or suspend the payment authorization on the daughter's smartphone through a cellular network connection (or any other long-range wireless connections).

This remote trust-modification feature is technically advantageous, because restricting or revoking a use credential stored on another user device may need to be made effective with urgency and immediacy to prevent potential (or even probable) unauthorized transactions; when a primary trusted device and a restricted trusted device are not with proximity to each other, a remote user credential control feature can provide increased data security.

In one embodiment, the use restrictions that may be imposed on a user credential include a total number of transaction restriction, a transaction frequency restriction, a transaction amount restriction, a transaction location restriction, a transaction party restriction, a merchandize restriction, or a combination thereof. For example, a restricted trust device may be used to make up to twenty payments based on a user credential given by a primary trusted device; the restricted trust device may be used to make no more than five online purchases based on the user credential; the restricted trust device may be used to make purchases under fifty dollars based on the user credential; the restricted trust device may be used to conduct transactions when connected to a home Wi-Fi network, rather than a cellular network; the restricted trust device may be used to conduct transactions when connected to a home Wi-Fi network, rather than a cellular, the restricted trust device may be used to conduct transactions with devices identified as smartphones belongs to a user's peers (e.g., fellow student or colleagues). In one embodiment, a primary trusted device may transmit a one-time use user credential to another user device, so that the other user device may conduct a single transaction with the user credential.

In one embodiment, the restricted trusted devices 1202B-1202E include smart-home appliances, for example, an electronic door lock, a dishwasher, a washer-and-dry pair, a video streaming TV device, an Internet phone, and a vacuum robot. A primary trusted device may transmit (e.g., actively pushing upon detection, as opposed to passively transmitting upon request) a user credential to these smart-home appliances to enable the appliances to conduct transactions with the user credential. Smart-home appliances may be restricted in how they may use a user credential to transact, e.g., which merchandize may be purchased and from which preferred merchants. For example, a dish washer may purchase dish detergents, but not groceries or stationaries, from an online store; a delivery receptacle may e-sign a delivery of women's fashion items on behalf of the user identified by the user credential, but may not sign a delivery of alcoholic beverages on behalf of the user.

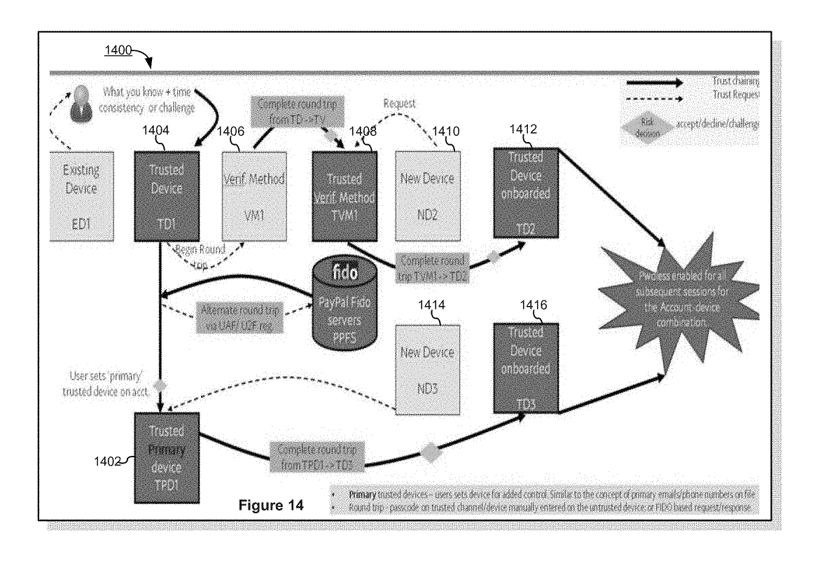

FIG. 14 is a schematic view illustrating an embodiment of a method 1400 for transmitting user data among user devices. The user device 1202, for example, when programmed in accordance with the technologies described in the present disclosure, can perform the method 1400.

As shown in FIG. 14, a user may designate a user device as a trusted device 1402 by, after a successful user authentication, registering a user name and a device identifier with a service provider. After the registration, the service provider deems the user device a trusted user device for the purpose of authenticating the user.

The user may further designate the trusted device 1402 to a primary trusted device. A primary trusted device can be thought of as a root node of a tree structure or the first link of a set of connected links. The user may use the primary trusted device 1402 to create second trusted devices, e.g., a secondary trusted device 1404.

On-boarding a new device as a trusted device may require user confirmation on an existing trusted device. For example, before adding the new device 1410 as an additional trusted device (for example, before wirelessly transmitting a user credential to the new device 1410), the service provider sends a request for confirmation through a verification method 1408 to a trusted device, e.g., a secondary trusted device 1404. A verification method may include a voice call, a text/instant message, or an email. A verification method may be designated a trusted verification method, if the verification method is confirmed as capable of reaching the user to whom the account belongs on a primary trusted device (also known as a trusted primary device in this filing). A trusted verification method, for example, may include a voice call or a text/instant message to a phone number previously verified as belonging to the user, an email to an email address previously verified as registered by the user, or an instant message to a messaging account verified as belonging to the user. After a user confirms adding the new device 1410 via the aforesaid trusted verification method, the new device 1410 is on-boarded as a trusted user device 1412.

A new device may also be on-boarded through the primary trusted device 1402. For example, before transmitting a user credential to another new device 1414, a user may need to directly confirm on the primary trusted device 1402 (as opposed to on the secondary trusted device 1402 or via the trusted verification method 1408). After the user confirmation, the new device 1414 may be on-boarded as a trusted device 1416. After a new device is on-boarded as a trusted device, a user may not need to provide a password for authenticating herself for logging in to one or more applications executing on the trust device.

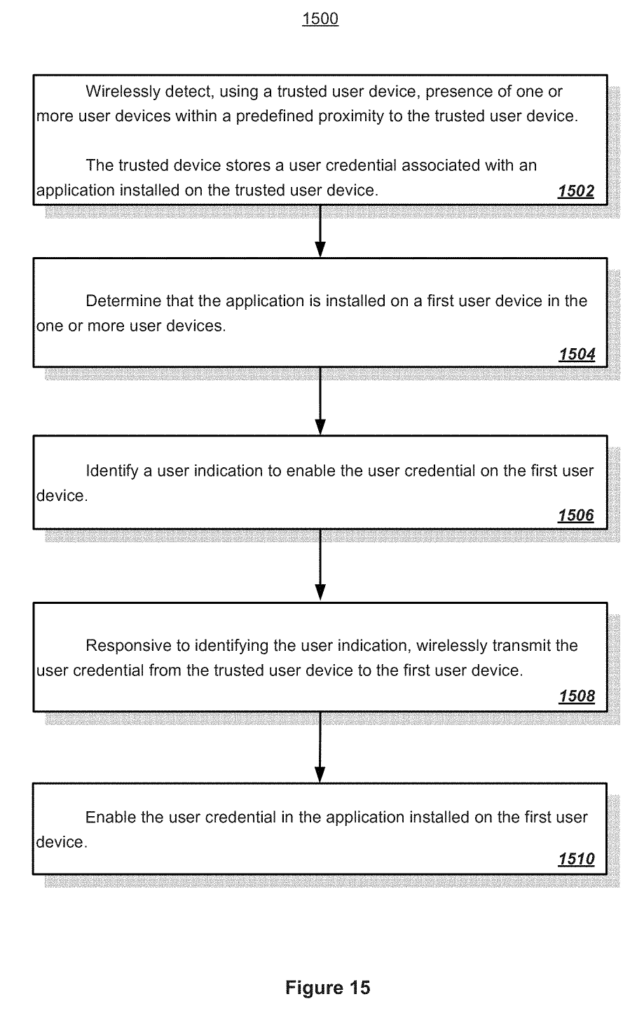

FIG. 15 is a flow chart illustrating an embodiment of a method 1500 for transmitting user data among user devices. The user device 1202, for example, when programmed in accordance with the technologies described in the present disclosure, can perform the method 1500.

A trusted user device may, in some implementations, first search for nearby (e.g., 3 feet, 10 feet, or 20 feet away, or other predetermined distance within communication range) user devices that are not yet trusted user devices. The method 1500 may therefore include wirelessly detecting (1502), using a trusted user device, the presence of one or more user devices within a predefined proximity to the trusted user device. In one embodiment, a device is considered nearby (or within a predefined proximity to) a trusted user device if the trusted user device can receive responses from the device using particular communication protocols, e.g., a BLE-based protocol, an NFC-based protocol, or an RFID-based protocol.

A trusted user device may be equipped with a hardware BLE communication module, an NFC communication module, or both. The trusted user device may activate one or more of these hardware communication modules and use BLE- or NFC-based communication protocols to detect the presence of user devices that are not trusted devices. These signals can be invoked simultaneously, or in some logical opportunistic manner. The sequence of communication protocols activated to detect devices can be optimized to a preset hierarchy, or a custom hierarchy based on an initial discovery broadcast for supported and active protocols in the environment. It can be a combination of signals based on their power consumption fingerprint, the number of devices in the vicinity and their individual system capability and characteristics. As explained in the present disclosure, these features are technically advantageous. First, using communication modules that require less energy consumption, especially when a trusted device may need to constantly seek out connections with other devices, can improve the service time of a trusted user device. Second, when a trusted user device is a mobile device (e.g., a wearable device, a tablet computer or a smartphone), maintaining the power consumption below a predefined level may be critical, as having wired power connections may be either unpractical or unaesthetic.

In some implementations, a user device is determined as a trusted user device if the user device locally stores, e.g., in a secure hardware element, a user credential. The method 1500 therefore optionally includes detecting that a secure key is stored on a user device; and responsive to the detecting, identifying the user device as a trusted user device. A user credential (sometimes also referred to as a secure key) may be generated for example using technologies described in U.S. patent application Ser. No. 15/193,487. An example user credential may include an encrypted user name-password pair or an encrypted device identifier.

A user credential may be application specific. For example, each application installed on a user device may be associated with its own user credential. For example, a payment application and an email application may have different user credentials. This is technically advantageous, because if the user credential for one application is comprised, the data security of other applications may not be affected. A user credential may also be device specific. For example, a user's fingerprint data may authenticate a user for the purpose of using all currently installed app on a single device, e.g., a smartphone.

After detecting nearby user devices that are not yet trusted devices, the trusted user device may determine whether the nearby devices have applications for which a user credential possessed by the trusted device can be enabled. The method 1500 may therefore include determining (1504) that the application is installed on a first user device in the one or more user devices. The trusted device may request, from a nearby device, a list of application identifiers (e.g., a string “taxi-app-1” or “Taxi_78_480”), each of which uniquely identifies an application installed on the nearby device. The trusted device may compare the list of application identifiers with application identifiers corresponding to the user credentials stored on the trusted device. When there is a matching identifier, the trusted device may determine that that user credential may be enabled on the corresponding application on the nearby device.

When a nearby device includes one or more applications for which a user credential can be enabled, the trusted device, in some implementations, requests a user confirmation before entrusting the nearby device, e.g., before transmitting the user credential to the nearby device. The method 1500 may provide, to a user, information identifying which device is being on-boarded as a trusted device and on which applications the user credential may be enabled; the user may need to specifically confirm these configurations before the nearby device can be on-boarded for security reasons.

When a user confirmation is obtained, the trusted device may wirelessly transmit one or more matching user credentials to the nearby device. The method 1500 may therefore include identifying (1506) a user indication to enable the user credential on the first user device; and responsive to identifying the user indication, wirelessly transmitting (1508) the user credential from the trusted user device to the first user device.

In the embodiments where user credentials are application specific and a nearby device includes multiple applications on which user credentials (possessed by the trusted device) can be enabled, the trusted device may transmit one or more user credentials to the nearby device and enable the user credentials on the respective applications.

In the embodiments where user credentials are application specific, the method 1500 may, based on a mapping table that include a set of mapping from a user credential to one or more applications (or apps) where the user credential can be used, identify, on a user device, one or more applications on which the user credential can be enabled. In some implementations, a credential match feature may be provided to automatically match credentials (e.g., matching a secure key with another secure key or recognizing a derivative key as being derived form a primary key) while transmitting user credentials to user devices and apps. Once a credential match is determined, the method 1500 may include the user device to which the user credential is being sent in the appropriate trust chain, which identifies a set of user devices as being owned by the same person, the same household, the same trusted family or friends. A user approval on a trusted device (e.g., primary or secondary) may be need being a new device is added to a trust chain based on a user credential match.

Enabling a user credential on a user device, in some implementations, includes activating the user login identified in the user credential in the corresponding application installed on the user device. For example, if a user credential allows the user name “HB_User1” to log into a taxi-sharing application on a trusted user device, then enabling the user credential on another device may include logging the user name “HB_User1” into the same taxi-sharing application installed on a different device.

An auto-enablement feature may be provided in different embodiments. For example, a user credential may be automatically enabled, for example, without requiring a user to take an affirmative action on either the trusted device, the device to be trusted, or both. A user credential is, in some implementations, automatically enabled on devices that are within a predefined proximity, such as within NFC range, to a trusted device.

An auto account replacement feature may also be provided. Enabling a user credential on a user device, in some implementations, includes replacing an existing user account logged into an application with the user account identified by the user credential. For example, if user_A's account is currently logged into a taxi_app installed on the user A's mobile phone, enabling user_B's credential on the taxi_app on user_A's phone may include replacing account information (e.g., payment methods, user_A's date of birth, current address, and phone number) or history (e.g., favorite pickup locations and ride history for the past 30 days) with those of the user_B obtained from the trusted device.

The method 1500 may therefore include determining a user account identified by the user credential; determining that the application installed on the first user device is logged in using a second user credential in response to the determining, logging the second user account out of the application installed on the first user device; and logging the user account into the application installed on the first user device. The second user credential identifies a second user account different from the user account.

Derivative user credentials may be enabled on a secondary trusted user device. For example, the primary trusted device may store a primary key, and a subsequently-on boarded trusted device may store a derivative key. A derivative key may be different from the primary key in that a derivative key may not be capable of on-boarding other devices or that a derivative key may not authenticate a user on devices other than the one where it was originally stored.

In other words, a derivative key may be device specific and thus not portable to another device. A device-specified derivative key may be generated based on a unique device identifier that identifies the trusted device on which the primary key is stored, the device on which the derivative key is stored, or both.

Having a hierarchy of user credentials is also technically advantageous. For example, a secondary trusted device (and the derivative key stored thereon) being comprised (e.g., lost or hacked) does not jeopardize the data security on a peer secondary trusted device or on the primary trusted device. For example, the primary trusted device (and the derivative key stored thereon) being comprised (e.g., lost or hacked) neither jeopardizes the data security on the secondary trusted devices nor breaks the trust chains established among the trusted device. A user does not need to duplicate the efforts made establishing the trust chains.

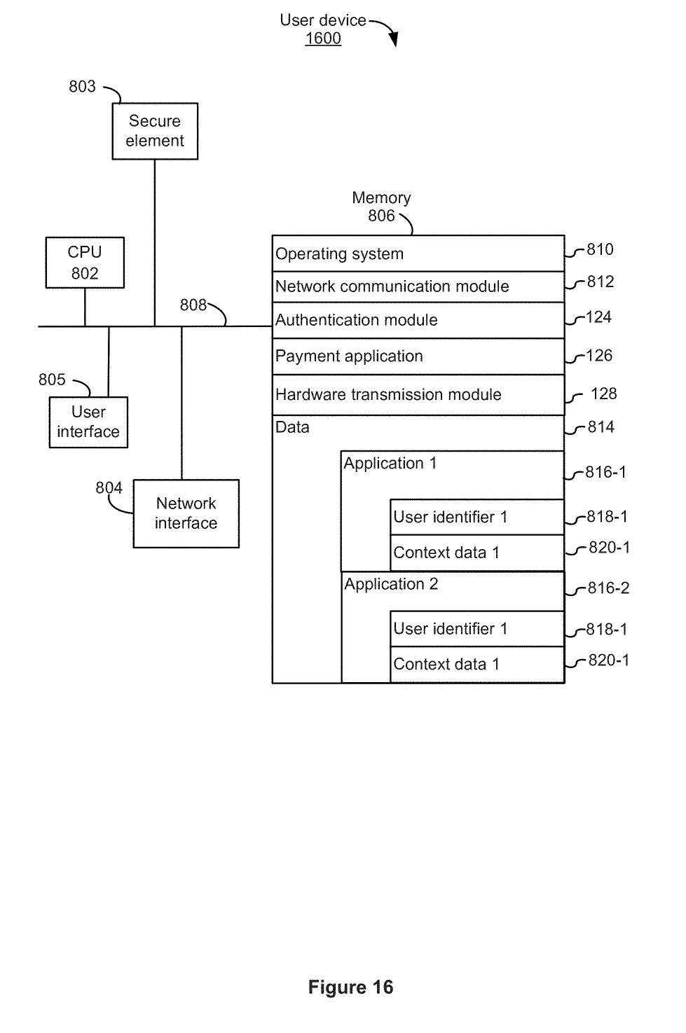

FIG. 16, discussed above, is a schematic view illustrating an embodiment of a user device 1600, which can also be the device 1202 shown in FIG. 12, where data 614 stored on the device may further include a global user account (e.g., a user account with a payment service provider), e.g., a payment account that a user of the user device has selected for payment on the at least one of the applications installed on the user device.

Further, the hardware transmission module 128 may actively seek out connections with other user devices. For example, using a BLE or an NFC connection, a primary trusted user device may broadcast a message to request other user devices located within a predetermined range (e.g., 30 feet) to respond and request to connect with a user device that has responded. A user device that broadcasts the request to connect is sometimes referred to the master device. The hardware transmission module 128 may also passively respond to a request to connect with a master device. A user device that responds to a request to connect broadcasted by a master device is sometimes referred to as a slave device.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the scope of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. For example, the above embodiments have focused on merchants and users; however, a user or consumer can pay, or otherwise interact with any type of recipient, including charities and individuals. The payment does not have to involve a purchase, but may be a loan, a charitable contribution, a gift, etc. Thus, merchant as used herein can also include charities, individuals, and any other entity or person receiving a payment from a user. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A system, comprising:
a non-transitory memory; and
one or more hardware processors coupled to the non-transitory memory and configured to execute instructions from the non-transitory memory to cause the system to perform operations comprising:
wirelessly detecting, using a trusted user device, presence of one or more user devices within a predefined proximity to the trusted user device, wherein the trusted device stores a user credential associated with an application installed on the trusted user device;
determining that the application is installed on a first user device different from the trusted user device in the one or more user devices;
identifying a user indication to enable use of the user credential on the first user device;
responsive to identifying the user indication, wirelessly transmitting the user credential from the trusted user device to the first user device; and
enabling the use of the user credential in the application installed on the first user device.

2. The system of claim 1, wherein the operations further comprise:
activating a hardware Bluetooth Low Energy (BLE) transmission module of the trusted user device; and
wirelessly detecting the presence of the one or more user devices using the hardware BLE transmission module.

3. The system of claim 1, wherein the operations further comprise:
activating a hardware Near Field Communication (NFC) module of the trusted user device; and
wirelessly detecting the presence of the one or more user devices using the NFC module.

4. The system of claim 1, wherein the operations further comprise:
detecting that a secure key is stored on a user device; and
responsive to the detecting, identifying the user device as the trusted user device.

5. The system of claim 4, wherein detecting that the secure key is stored on a user device comprises detecting that the secure key is stored in a secure hardware element of the user device.

6. The system of claim 1, wherein enabling the use of the user credential in the application installed on the first user device comprises providing the user credential to a user account associated with the application installed on the first user device.

7. The system of claim 1, wherein enabling the use of the user credential in the application installed on the first user device does not require a user action on the first user device.

8. The system of claim 1, wherein the operations further comprise imposing one or more use restrictions on the application installed on the first user device.

9. The system of claim 8, wherein the one or more use restrictions include one of: a number of transaction restriction, a transaction frequency restriction, a transaction amount restriction, a transaction location restriction, a transaction party restriction, or a merchandize restriction.

10. A non-transitory machine-readable medium having stored thereon machine-readable instructions executable to cause a machine to perform operations comprising:
wirelessly detecting, using a trusted user device, presence of one or more user devices within a predefined proximity to the trusted user device, wherein the trusted device stores a user credential associated with an application installed on the trusted user device;
determining that the application is installed on a first user device different from the trusted user device in the one or more user devices;
identifying a user indication to enable use of the user credential on the first user device;
responsive to identifying the user indication, wirelessly transmitting the user credential from the trusted user device to the first user device; and
enabling the use of the user credential in the application installed on the first user device.

11. The non-transitory machine-readable medium of claim 10, wherein the operations further comprise:
wirelessly disabling, using the trusted user device, the user credential in the application installed on the first user device.

12. The non-transitory machine-readable medium of claim 10, wherein enabling the user credential in the application installed on the first user device comprises:
determining a user account identified by the user credential;
determining that the application installed on the first user device is logged in using a second user credential, wherein the second user credential identifies a second user account different from the user account;
in response to the determining, logging the second user account out of the application installed on the first user device; and
logging the user account into the application installed on the first user device.

13. The non-transitory machine-readable medium of claim 10, wherein the operations further comprise:
activating a hardware Bluetooth Low Energy (BLE) transmission module of the trusted user device; and
wirelessly detecting the presence of the one or more user devices using the hardware BLE transmission module.

14. The non-transitory machine-readable medium of claim 10, wherein the operations are executed using a short-range wireless communication protocol.

15. The non-transitory machine-readable medium of claim 14, wherein the operations further comprise: restricting, from the trusted user device, use of the user credential in the application installed on the first user device using a long-range wireless communication protocol.

16. The non-transitory machine-readable medium of claim 10, wherein the user credential identifies a payment account.

17. A method, comprising:
wirelessly detecting, using a trusted user device, presence of one or more user devices within a predefined proximity to the trusted user device, wherein the trusted device stores a user credential associated with an application installed on the trusted user device;
determining that the application is installed on a first user device different from the trusted user device in the one or more user devices;
identifying a user indication to enable use of the user credential on the first user device;
responsive to identifying the user indication, wirelessly transmitting the user credential from the trusted user device to the first user device; and
enabling the use of the user credential in the application installed on the first user device.

18. The method of claim 17, further comprising:
activating a hardware Bluetooth Low Energy (BLE) transmission module of the trusted user device; and
wirelessly detecting the presence of the one or more user devices using the hardware BLE transmission module.

19. The method of claim 17, further comprising:
identifying a primary key corresponding to the user credential associated with the application on the trusted user device;
and wherein enabling the user credential in the application installed on the first user device comprises:
storing a derivative key corresponding to the user credential in a secure hardware element of the first user device.

20. The method of claim 17, further comprising identifying the first user device as a secondary trusted user device.
